(19) United States
(12) Patent Application Publication
(10) Pub. No.: US 2007/0199583 A1
(43) Pub. Date: Aug. 30, 2007

(54) Semiconductor inspecting apparatus having device for cleaning tip of probe card and method for cleaning the tip

(76) Inventors: Ji-Man Choi, Yongin-si (KR); Duk-Kyeom Kim, Suwon-si (KR); Byung-Jun Moon, Suwon-si (KR); Ju-Hyun Nam, Suwon-si (KR); In-Cheol Lee, Hwaseong-gun (KR)

Correspondence Address: LEE & MORSE, P.C., 3141 FAIRVIEW PARK DRIVE, SUITE 500, FALLS CHURCH, VA, 22042, US

(21) Appl. No.: 11/711,786

(22) Filed: Feb. 28, 2007

(30) Foreign Application Priority Data
Feb. 28, 2006 (KR) 2006-19489

(51) Int. Cl. B08B 3/00

(52) U.S. Cl. 134/94.1; 134/198

(57) ABSTRACT

An apparatus for inspecting a semiconductor and a method for automatically cleaning the tip of a probe card may include an inspection chamber having a probe card for inspecting a wafer, and a chemical-wetting chamber for applying a chemical agent to a cleaning member. The inspection chamber and the chemical-wetting chamber may be integral parts of the apparatus.

### BACKGROUND OF THE INVENTION

1. Field of the Invention

The present invention disclosed herein relates to a semiconductor inspecting apparatus, and more particularly, to a semiconductor inspecting apparatus that can reduce and/or eliminate foreign material from a tip of a probe card while maintaining a structural integrity of the tip of the probe card, i.e., while not wearing down the tip of the probe card.

2. Description of the Related Art

Generally, an electrical die sorting (EDS) inspection process is performed in order to determine whether a chip formed on a semiconductor wafer is good or bad. The EDS inspection apparatus may apply an electric signal to the chip formed on the wafer. A probe card may be used as the inspecting apparatus. The probe card may be provided with a tip to contact a pad formed on a wafer, and may apply an electric signal to the pad.

When the tip contacts the pad, which may be aluminum, an arcing phenomenon may occur between the tip and the pad. More particularly, when the tip contacts the pad, a portion of the aluminum pad near the tip that may be molten may adhere to the tip and may act as a foreign object. The foreign object may distort the shape of the tip and increase the contact resistance with the pad. The shape distortion and increased resistance may distort the electric signals between the pad and the tip. Signal distortion may result in abnormal function of the tip, e.g., inspection errors.

To address the above problems, the end of the tip having an attached foreign object may be mechanically polished with a polishing sheet atop a polishing wafer so as to remove the foreign object. The mechanical polishing process may remove the foreign object by repeatedly rubbing the extreme end of the tip with the polishing sheet. The polishing process may wear down the end of the tip and may reduce the service life of the tip.

### SUMMARY OF THE INVENTION

The present invention is therefore directed to an inspection apparatus having a device for cleaning the tip of the probe card, and a method for cleaning a probe tip, which substantially overcome one or more of the problems due to limitations and disadvantages of the related art.

It is therefore a feature of an embodiment of the invention to provide a tip cleaning device that may chemically remove foreign material from the tip of the probe card while maintaining a structural integrity of the tip, i.e., without wearing down the tip.

It is therefore a feature of an embodiment of the present invention to provide apparatuses for inspecting a semiconductor that may include an inspection chamber having a probe card for inspecting a wafer, and a chemical-wetting chamber having at least one cleaning member for applying at least one chemical agent to a tip of the probe card, wherein the inspection chamber and the chemical-wetting chamber may be integral parts of the apparatus.

In some embodiments, the cleaning member may include an absorbent material attached thereon. The chemical-wetting chamber may include at least one nozzle for supplying at least one chemical agent to the at least one cleaning member and at least one tray for supporting the at least one cleaning member.

In other embodiments, the cleaning member may include a first cleaning member for receiving a cleaning chemical agent and a second cleaning member for receiving a rinsing chemical agent. The first cleaning member and the second cleaning member may be plate-like. The at least one tray may include a first tray for supporting the first cleaning plate and a second tray for supporting the second cleaning plate.

In still other embodiments, the at least one nozzle may include a first nozzle for supplying the cleaning chemical agent to the first cleaning plate and a second nozzle for supplying the rinsing chemical agent to the second cleaning plate. The first nozzle may be attached to a cleaning agent supply pipe and rinsing chemical supply pipe to selectively supply one of the cleaning and rinsing agents to the first cleaning plate. The second nozzle may be attached to a cleaning agent supply pipe and a rinsing agent supply pipe to selectively supply one of the cleaning and rinsing agents to the second cleaning plate.

In even other embodiments, the chemical-wetting chamber may include at least one selected from the group consisting of a shielding plate, an exhaust fan, and a drain pan having a drain pipe. The inspection chamber may include an air nozzle for drying the tip of the probe card.

In yet other embodiments, the apparatus may further include a storing chamber for storing the wafers and a transfer chamber having at least one arm for transferring the wafers between the storing chamber and the inspection chamber, and for transferring the at least one cleaning member between the inspection chamber and the chemical-wetting chamber.

In other embodiments of the present invention, apparatuses for inspecting a semiconductor may include an inspection chamber having a chuck for supporting a production wafer, a probe card disposed over and in contact with the wafer, and an air nozzle disposed toward the probe card, a chemical-wetting chamber having a chemical nozzle for selectively spraying cleaning and rinsing chemical agents, a cleaning wafer tray for storing and supporting an absorbent cloth-faced cleaning wafer to receive the chemical agent, and a rinsing wafer tray for storing and supporting an absorbent cloth-faced rinsing wafer to receive the rinsing chemical agent, and a pincer arm disposed in a transfer chamber for transferring the cleaning wafer and rinsing wafer between the chemical-wetting chamber and the inspection chamber.

In some embodiments, the chemical-wetting chamber may include a first shielding plate disposed over the cleaning wafer and a second shielding plate disposed over the rinsing wafer.

In other embodiments, the chemical-wetting chamber may further include a drain pan disposed beneath the trays. The chemical-wetting chamber may further include an exhaust fan disposed in a wall of the chemical-wetting chamber.

In still other embodiments, the chemical nozzle may include a first nozzle for supplying the cleaning chemical agent to the cleaning wafer and a second nozzle for supplying the rinsing chemical agent to the rinsing wafer.

In even other embodiments, the chemical nozzle may include a first pipe for selectively supplying one of the cleaning and rinsing chemical agents and a second pipe for supplying air. The first pipe may be attached to a cleaning agent supply pipe and a rinsing chemical supply pipe.

In still other embodiments of the present invention, methods for cleaning a tip of a probe card may include applying a cleaning chemical agent onto a cleaning wafer in a chemical-wetting chamber, cleaning a tip of a probe card by contacting the tip of the probe card with the cleaning wafer in an inspection chamber, applying a rinsing chemical agent onto the rinsing wafer in the chemical-wetting chamber, rinsing the tip of the probe card by contacting the tip of the probe card with the rinsing wafer in the inspection chamber, and drying the tip of the probe card in the inspection chamber.

In some embodiments, the cleaning chemical agent may be tetrabutyl ammonium hydroxide and the rinsing chemical agent may be isopropyl alcohol.

According to the present invention, since the foreign object is removed from the tip of the probe card through a chemical process rather than the conventional forced wearing method, the wear of the probe card tip can be prevented.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic view of a semiconductor inspection apparatus having a device for cleaning a tip of a probe card according to an embodiment of the present invention;

FIG. 2 illustrates a perspective view of a chuck provided in a test chamber of the semiconductor inspection apparatus of FIG. 1;

FIG. 3 illustrates a perspective view of a nozzle and a tray in a chemical-wetting chamber of the semiconductor inspection apparatus of FIG. 1;

FIG. 4 illustrates a general cross-sectional view of an inspection apparatus in a wafer production state in which foreign material is adhered to a tip of a probe card;

FIG. 5 illustrates a general cross-sectional view of the inspection process shown in FIG. 4 in a cleaning state during which foreign material is being removed from the probe tip according to an embodiment of the invention;

FIGS. 6A and 6B illustrate graphs showing contact resistance properties of an uncleaned tip and a cleaned tip, respectively;

FIG. 7 illustrates a sectional view of a method of rinsing a tip of a probe card according to an embodiment of the present invention; and

FIG. 8 illustrates a flowchart of a method for cleaning a tip of a probe card according to an embodiment of the present invention.

### DETAILED DESCRIPTION OF THE INVENTION

Korean Patent Application No. 2006-19489, filed on Feb. 28, 2006, in the Korean Intellectual Property Office, and entitled: “Semiconductor Inspecting Apparatus Having Device for Cleaning Tip of Probe Card and Method for Cleaning the Tip,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. In the figures, the dimensions of layers and regions are exaggerated for clarity of illustration.

Hereinafter, exemplary embodiments of the present invention in conjunction with the accompanying drawings.

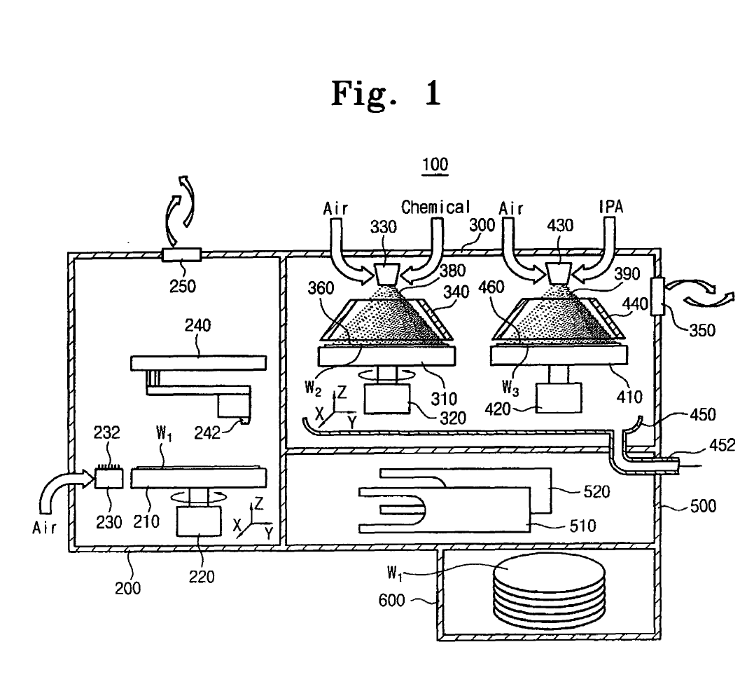

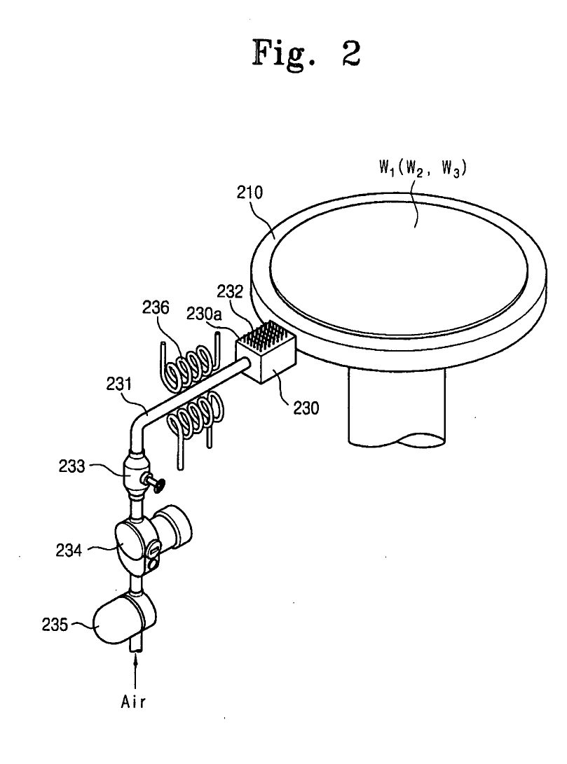

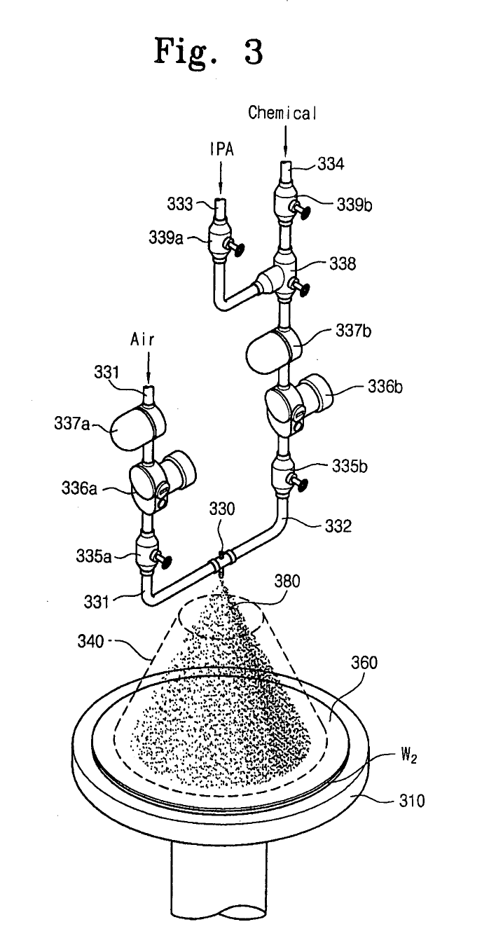

FIG. 1 illustrates a schematic view of a semiconductor inspection apparatus having a device for cleaning a tip of a probe card according to an embodiment of the present invention, FIG. 2 illustrates a perspective view of a chuck provided in a test chamber of the semiconductor inspection apparatus of FIG. 1, and FIG. 3 illustrates a perspective view of a nozzle and a tray in a chemical-wetting chamber of the semiconductor inspection apparatus of FIG. 1.

Referring to FIG. 1, a semiconductor inspection apparatus 100 may be configured to perform an EDS process to determine if a semiconductor chip formed on a wafer W, is good or bad. The semiconductor apparatus 100 may include an inspection chamber 200, a chemical-wetting chamber 300, a transfer chamber 500, and a storing chamber 600.

The inspection chamber 200 may provide an enclosed space in which the EDS process is performed. A probe card 240 may have a tip 242 for contacting a production wafer W₁ and applying an electric signal thereto. The production wafer W₁ may be a wafer that is being manufactured and tested. A chuck 210 may be provided in the inspection chamber 200 to hold the production wafer W₁. A driving unit 220 may be combined with the chuck 210 to move the chuck 210 in the X, Y and Z axes and to rotate the chuck 210. A nozzle 230 may also be provided in the inspection chamber for removing foreign material from a probe card tip 242. An exhaust fan 250 may be installed in the inspection chamber 200.

Referring to FIG. 2, the chuck 210 may use a vacuum source to hold a wafer W₁ during the testing process. The nozzle 230 may be attached to a fluid line 231 through which a drying fluid, e.g., air, may be introduced to the tip 242. The flow of the air to the nozzle 230 may be controlled by a valve 233. The flow rate of the air to the nozzle 230 may be controlled by a regulator 234. The air may pass through a filter 235 to remove foreign material. A heater 236 may be disposed around the air fluid line 231 to heat the air. The air may be sprayed from a top surface 230a of the nozzle 230. The top surface 230a may include a brush 232. The nozzle 230 may be disposed under the tip 242 so that the tip 242 may receive drying air from the top surface 230a of the nozzle 230 and may be brushed to remove foreign material or objects with the brush 232.

Referring again to FIG. 1, the chemical-wetting chamber 300 may provide an enclosed space to store and set a cleaning wafer W₂ and a rinsing wafer W₃, which may be used for cleaning and rinsing the tip 242 of the probe card 240. The cleaning wafer W₂ and the rinsing wafer W₃ may be similar in form to the production wafer W₁ to simplify the structure of the apparatus 100. In addition, the chuck 210, or a similar chuck, may be used to support the cleaning wafer W₂ and the rinsing wafer W₃, to further enhance efficiency.

A cloth 360 or absorbent material may be attached on a surface of the cleaning wafer W₂ by a resin. The cloth 360 may include a cleaning agent, and the tip 242 may be rubbed against the cloth 360 and cleaning agent. Likewise, a cloth 460 may be attached on a surface of the rinsing wafer W₃ for a similar purpose. The chemical wetting chamber 300 may be divided into a first section and a second section. The cleaning wafer W₂ may be stored and set in the first section, e.g., the cleaning agent may be sprayed onto the cleaning wafer W₂ in the first section. The rinsing wafer W₃ may be stored and set in the second section, e.g., a rinsing agent may be sprayed onto the rinsing wafer W₃ in the second section.

The first section of the chemical-wetting chamber 300 may include a tray 310 for storing and supporting the cleaning wafer W₂ and a nozzle 330 for mixing and spraying the cleaning agent onto the cleaning wafer W₂. The tray 310 may be rotatable and movable in the X, Y and Z directions by a driving unit 320. When the cleaning agent is sprayed onto the cleaning wafer W₂, a shielding plate 340 may control overspray and prevent the cleaning agent from contaminating, damaging or corroding an inner wall of the chemical-wetting chamber 300 or other components, e.g., the tray 310, the nozzle 330, or the driving unit 320. The cleaning agent may include a chemical composition that can remove the foreign material adhered to the tip 242. The foreign material may be, e.g., a piece of aluminum from the pad 101 that may have melted and stuck to the tip 242. The cleaning agent may be, e.g., tetrabutyl ammonium hydroxide.

The second section of the chemical-wetting chamber 300 may include a tray 410 for storing and supporting the rinsing wafer W₃. A nozzle 430 may be provided for mixing and spraying the rinsing agent onto the rinsing wafer W₃. The tray 410 may be rotatable and movable in the X, Y and Z directions by a driving unit 420. When the rinsing agent is sprayed onto the rinsing wafer W₃, a shielding plate 440 may reduce and/or prevent the rinsing agent from scattering and contaminating the inner wall of the chemical-wetting chamber 300 or other components, e.g., the tray 410, the nozzle 430, and the driving unit 420. For the rinsing wafer W₃, the rinsing agent may include, e.g., isopropyl alcohol (IPA) to rinse the tip 242.

An exhaust fan 350 may be provided to exhaust agents or fumes from the chemical-wetting chamber 300. A drain pan 450 may be provided in a lower end of the chemical-wetting chamber 300 to receive the excess cleaning and rinsing agents. The agents received in the drain pan 450 may be drained through a drain pipe 452.

Referring to FIG. 3, the nozzle 330 may be connected to a chemical line 332 and an air line 331. The cleaning agent, e.g., tetrabutyl ammonium hydroxide, for removing the foreign material, e.g., aluminum, adhered to the tip 242 may be introduced into the chemical line 332. The flow of the cleaning agent to the nozzle 330 may be controlled by a valve 335b and the flow rate of the cleaning agent may be controlled by a regulator 336b. At this point, the cleaning agent may pass through a filter 337b to remove foreign objects. Likewise, any air used for spraying the chemical agent from the nozzle 330 may be introduced into the air line 331. The flow of the air to the nozzle 330 may be controlled by a valve 335a and the flow rate of the air may be controlled by a regulator 336a. The air may pass through a filter 337a to remove foreign objects.

In one embodiment, the chemical line 332 may receive chemical agents from two other chemical lines 333 and 334. The cleaning agent, e.g., tetrabutyl ammonium hydroxide, may be supplied to the nozzle 330 through chemical line 334 and the rinsing agent, e.g., IPA, may be supplied to the nozzle 330 through chemical line 333. The cleaning agent and the rinsing agent may be selectively supplied to the nozzle 330 by the operation of a switching valve 338. Supply valves 339a and 339b may control the flow of the rinsing agent and the cleaning agent, respectively. Cleaning agent supplied to the nozzle 330 may also clean the chemical line 332. The cleaning agent spray 380 may be sprayed from the nozzle 330 onto the cloth 360. The shielding plate 340 may control overspray.

The above-described structure may be applied in whole or part to the nozzle 430 installed at the second section of the chemical-wetting chamber 300. Therefore, the trays 310, 410 and the nozzles 330, 430 installed in the chemical-wetting chamber 300 may be compatible with each other. That is, either tray 310, 410 and either nozzle 330, 430 may be used to store and set either the cleaning wafer W₂ or rinsing wafer W₃.

For example, the cleaning wafer W₂ may be stored on the tray 310 and the cleaning agent, e.g., tetrabutyl ammonium hydroxide, and air may be supplied to the cloth 360 attached on the top surface of the cleaning wafer W₂. The rinsing wafer W₃ may be stored on the tray 410 and the rinsing agent, e.g., IPA, and air may be supplied to the cloth 460 attached on the top surface of the cleaning wafer W₃. Alternatively, the rinsing wafer W₃ may be stored on the tray 310 and the rinsing agent, e.g., IPA, and air may be supplied to the cloth 360 attached on the top surface of the cleaning wafer W₃. In addition, the cleaning wafer W₂ may be stored on the tray 410 and the cleaning agent, e.g., tetrabutyl ammonium hydroxide, and air may be supplied to the cloth 460 attached on the top surface of the cleaning wafer W₂.

In some embodiments, only one nozzle may be installed in the chemical-wetting chamber 300. That is, the cleaning agent and the rinsing agent may be selectively supplied through a single nozzle 330.

Referring again to FIG. 1, the apparatus 100 may include a pair of pincer arms 510, 520 in the transfer chamber 500. The pincer arms 510, 520 may load and unload the production wafer W₁ from the inspection chamber 200. One of the pincer arms 510, 520 may be for loading while the other pincer arm 510, 520 may be for unloading. The storing chamber 600 may temporarily store the production wafers W₁. A member for loading the wafers W₁, e.g., a cassette or front opening unified pod (FOUP), may be installed in the storing chamber 600.

Exemplary operation of the above-described inspection apparatus will be described below.

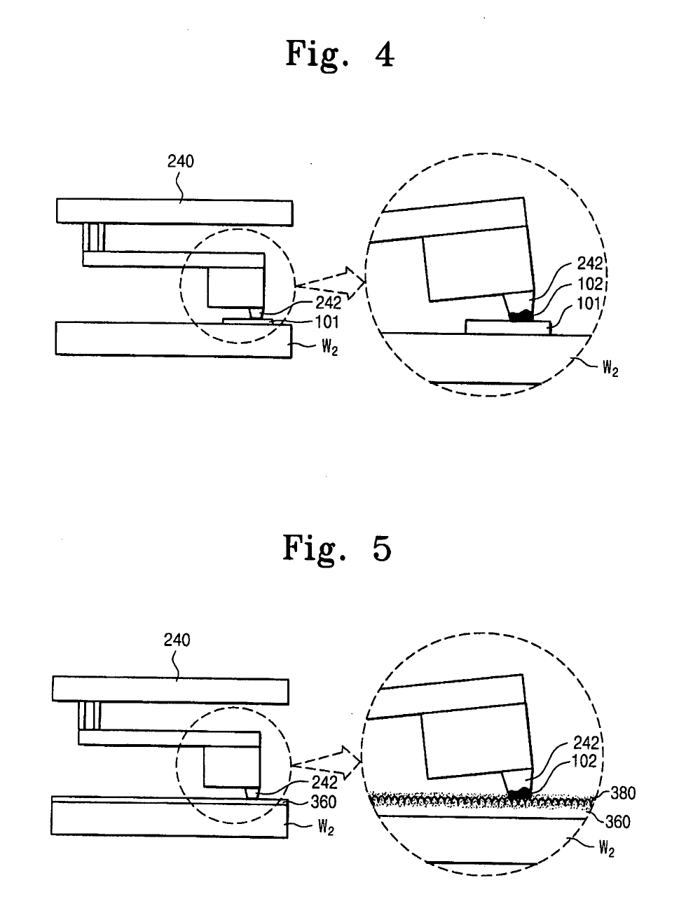

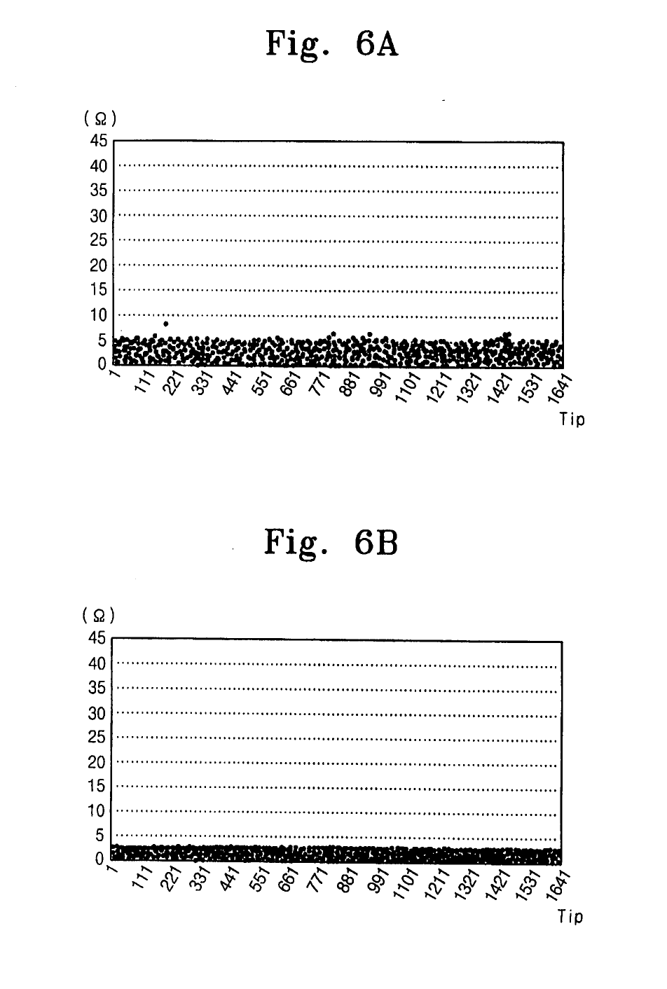

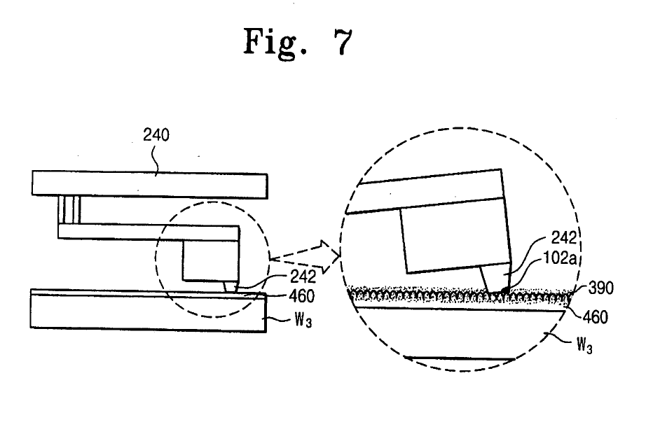

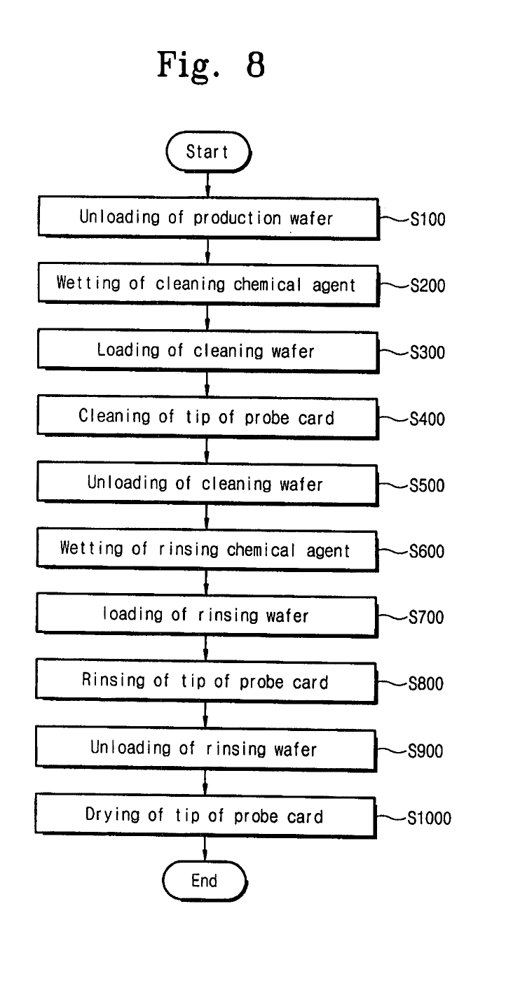

FIG. 4 illustrates a general cross-sectional view of an inspection apparatus in a wafer production state in which foreign material is adhered to a tip of a probe card, FIG. 5 illustrates a general cross-sectional view of the inspection process shown in FIG. 4 in a cleaning state during which foreign material is being removed from the probe tip according to an embodiment of the invention, FIGS. 6A and 6B illustrate graphs showing contact resistance properties of an uncleaned tip and a cleaned tip, respectively, FIG. 7 illustrates a sectional view of a method of rinsing a tip of a probe card according to an embodiment of the present invention, and FIG. 8 illustrates a flowchart of a method for cleaning a tip of a probe card according to an embodiment of the present invention. Referring to FIG. 8, a production wafer W₁ may be unloaded at step S100. After inspection, a pincer arm 510, 520 may grasp the production wafer W₁ from the inspection chamber 200 and transfer it to the storing chamber 600. During the inspection process, as shown in FIG. 4, pad material, e.g., aluminum, may be molten by an electric discharge between the aluminum pad 101 formed on the production wafer W₁ and the probe tip 242. Some of this material may adhere to the tip 242 of the probe card 240. The material 102 adhering to the tip 242 may increase the contact resistance between the tip 242 and the pad 101 and may distort the electric signal between them. This may result in an inspection error. The material 102 adhering to the tip 242 may be removed to restore normal operation. The following describes an exemplary embodiment of a cleaning method for removing foreign material, e.g., aluminum material 102, from the tip 242.

In step S200 of the cleaning method, the cleaning agent spray 380, e.g., tetrabutyl ammonium hydroxide, may be applied to the cleaning wafer W₂ which may be disposed on the tray 310 in the chemical-wetting chamber 300. The cleaning agent spray 380 may be sprayed from the nozzle 330 onto the cloth 360. The cleaning wafer W₂ may be rotated so that the cleaning agent spray 380 may be evenly distributed onto and absorbed into the cloth 360.

In step S300 of the cleaning method, the cleaning wafer W₂ may be loaded onto the chuck 210 using one of the pincers 510, 520. The cleaning wafer W₂ may be aligned with the probe card 240.

In step S400 of the cleaning method, the chuck 210 may be raised, or the probe card 240 may be lowered, so that the cleaning wafer W₂ contacts the tip 242 of the probe card 240. Accordingly, as shown in FIG. 5, an end of the tip 242 may contact the cleaning agent-laden cloth 360. The cleaning agent in the cloth 360 may dissolve the material 102 adhering to the tip 242, thereby substantially and/or completely removing the material 102 from the tip 242. Upon removal of the material 102 from the tip 242, the contact resistance between the tip 242 and the pad 101 may be greatly reduced. FIG. 6A illustrates the contact resistance with aluminum material 102 on the tip 242. FIG. 6B illustrates the great reduction in the contact resistance after removal of the aluminum material 102.

In step S500 of the cleaning method, one of the pincer arms 510, 520 may remove the cleaning wafer W₂ from the chuck 210 and transfer it to the tray 310 of the chemical-wetting chamber 300. The cleaning wafer W₂ may be processed with the cleaning agent at the tray 310, and may be stored there until needed again.

In step S600 of the cleaning method, rinsing agent spray 390 may be applied to the cleaning wafer W₃ disposed on tray 410 of the chemical-wetting chamber 300. The rinsing agent spray 390 may be sprayed from the nozzle 430 onto the cloth 460. The rinsing wafer W₃ may be rotated so that the rinsing agent can be evenly absorbed in the cloth 460.

In step S700 of the cleaning method, the rinse agent-laden rinsing wafer W₃ may be loaded onto the chuck 210 using one of the pincer arms 510, 520. The rinsing wafer W₃ may then be aligned with the probe card 240.

In step S800 of the cleaning method, the rinsing wafer W₃ may be placed into contact with the tip 242 by raising the chuck 210 and/or lowering the probe card 240. Accordingly, as shown in FIG. 7, an end of the tip 242 may be in contact with the cloth 460. The rinsing agent in the cloth 460 may remove some or all of the cleaning agent remaining on the tip 242. At this point, the material 102 may be substantially and/or completely removed from the tip 242.

In step S900 of the cleaning method, one of the pincer arms 510, 520 may grasp the rinsing wafer W₃ and load it onto the chuck 210 for transfer to tray 410 in the chemical-wetting chamber 300. The rinsing wafer W₃ may be processed with the rinsing agent at the tray 410, and may be stored there until needed again.

In step S1000 of the cleaning method, air may be blown from nozzle 230 onto the tip 242 to dry it. The tip 242 may also be brushed by the brush 232 provided on the top surface 230a of the nozzle 230 to remove some or all of the foreign material remaining on the tip 242. Thus, the tip 242 may be cleaned, rinsed and dried through the series of above-described processes so that it can effectively inspect the production wafers W₁.

According to the present invention, the foreign material 102 adhering to the tip of the probe card 240 may be substantially and/or completely removed using a chemical method rather than a physical method, preventing the wear of the tip 242. That is, embodiments of the invention may enable foreign material 102 to be removed from the probe tip 242 while maintaining structural integrity of the probe tip 242. Therefore, the service life of the probe card 240 may be increased, thereby reducing the maintenance costs of the apparatus. Furthermore, since the semiconductor inspection and tip cleaning may be conducted within a single semiconductor inspection apparatus, the time required to clean the tip may be shortened and manufacturing costs and time can be minimized.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An apparatus for inspecting a semiconductor, comprising:
an inspection chamber having a probe card for inspecting a wafer; and
a chemical-wetting chamber for applying a chemical agent to a cleaning member for cleaning a tip of the probe card,
wherein the inspection chamber and the chemical-wetting chamber are integral parts of the apparatus.

2. The apparatus as claimed in claim 1, wherein the cleaning member comprises an absorbent material attached thereon.

3. The apparatus as claimed in claim 1, wherein the chemical-wetting chamber comprises:
at least one nozzle for supplying the at least one chemical agent to the at least one cleaning member; and
at least one tray for supporting the at least one cleaning member.

4. The apparatus as claimed in claim 3, wherein the at least one cleaning member includes:
a first cleaning member for receiving a cleaning chemical agent; and
a second cleaning member for receiving a rinsing chemical agent, wherein the first cleaning member and the second cleaning member are plate-like members.

5. The apparatus as claimed in claim 4, wherein the at least one tray includes:
a first tray for supporting the first cleaning plate; and
a second tray for supporting the second cleaning plate.

6. The apparatus as claimed in claim 4, wherein the at least one nozzle includes:
a first nozzle for supplying the cleaning chemical agent to the first cleaning plate; and
a second nozzle for supplying the rinsing chemical agent to the second cleaning plate.

7. The apparatus as claimed in claim 6, wherein the first nozzle is attached to a cleaning chemical agent supply pipe and a rinsing chemical agent supply pipe,
wherein the cleaning agent and the rinsing agent are selectively supplied to the first cleaning plate.

8. The apparatus as claimed in claim 6, wherein the second nozzle is attached to a cleaning chemical agent supply pipe and a rinsing chemical agent supply pipe, wherein the cleaning agent and the rinsing agent are selectively supplied to the second cleaning plate.

9. The apparatus as claimed in claim 3, wherein the chemical-wetting chamber includes at least one selected from the group consisting of a shielding plate, an exhaust fan, and a drain pan having a drain pipe.

10. The apparatus as claimed in claim 1, wherein the inspection chamber includes an air nozzle and a brush disposed toward the probe card.

11. The apparatus as claimed in claim 1, further comprising:
a storing chamber for storing the wafers; and
a transfer chamber having at least one arm for transferring the wafers between the storing chamber and the inspection chamber, and for transferring the at least one cleaning member between the inspection chamber and the chemical-wetting chamber.

12. An apparatus for inspecting a semiconductor, comprising:
an inspection chamber having a chuck for supporting a wafer, a probe card disposed over and in contact with the wafer, and an air nozzle disposed toward the probe card;
a chemical-wetting chamber having a chemical nozzle for selectively spraying cleaning and rinsing chemical agents, a cleaning wafer tray for storing and supporting an absorbent cloth-faced cleaning wafer to receive the cleaning chemical agent, and a rinsing wafer tray for storing and supporting an absorbent cloth-faced rinsing wafer to receive the rinsing chemical agent; and
a pincer arm disposed in a transfer chamber for transferring the cleaning wafer and rinsing wafer between the chemical-wetting chamber and the inspection chamber.

13. The apparatus as claimed in claim 12, wherein the chemical-wetting chamber includes a first shielding plate disposed over the cleaning wafer and a second shielding plate disposed over the rinsing wafer.

14. The apparatus as claimed in claim 12, wherein the chemical-wetting chamber further includes a drain pan disposed beneath the trays.

15. The apparatus as claimed in claim 12, wherein the chemical-wetting chamber further includes an exhaust fan disposed in a wall of the chemical-wetting chamber.

16. The apparatus as claimed in claim 12, wherein the chemical nozzle includes:
a first nozzle for supplying the cleaning chemical agent to the cleaning wafer; and
a second nozzle for supplying the rinsing chemical agent to the rinsing wafer.

17. The apparatus as claimed in claim 12, wherein the chemical nozzle includes;
a first pipe for selectively supplying one of the cleaning and rinsing chemical agents; and
a second pipe for supplying air.

18. The apparatus as claimed in claim 17, wherein the first pipe is attached to a cleaning agent supply pipe and a rinsing chemical supply pipe.

19. A method for cleaning an apparatus for inspecting a semiconductor, comprising:
applying a cleaning chemical agent onto a cleaning wafer in a chemical-wetting chamber;
cleaning a tip of a probe card by contacting the tip of the probe card with the cleaning wafer in an inspection chamber;
applying a rinsing chemical agent onto a rinsing wafer in the chemical-wetting chamber;
rinsing the tip of the probe card by contacting the tip of the probe card with the rinsing wafer in the inspection chamber; and
drying the tip of the probe card in the inspection chamber.

20. The method as claimed in claim 19, wherein the cleaning chemical agent is tetrabutyl ammonium hydroxide and the rinsing chemical agent is isopropyl alcohol.
